(19) United States
(12) Patent Application Publication
(10) Pub. No.: US 2010/0289293 A1
(43) Pub. Date: Nov. 18, 2010

(54) ROLLING TYPE COVER DEVICE

(76) Inventor: Jong Su Kwag, Seoul (KR)

Correspondence Address: CHRISTOPHER PAUL MITCHELL, 888 16TH ST., NW, SUITE 800, WASHINGTON, DC, 20006, US

(21) Appl. No.: 12/810,842

(22) PCT Filed: Dec. 15, 2008
(86) PCT No.: PCT/KR2008/007413

§ 371 Date: Jun. 26, 2010

(30) Foreign Application Priority Data
Dec. 27, 2007 (KR) 10-2007-0138559

(51) Int. Cl. B60P 7/04

(52) U.S. Cl. 296/136.01

(57) ABSTRACT

The present invention relates to a rolling type cover device, and more particularly, to a device, which draws out a cover and covers a two-wheeler or automobile with the cover to protect the vehicle and winds the cover to enable it to be kept conveniently when the cover is not utilized. The rolling type cover device comprises a mid-sheet shaft (100) having a mid-sheet (110) wound thereon; a cover shaft (200) rotating by a rotational force-inputting means to allow a cover (210) and the mid-sheet (110) to be stacked and wound on the cover shaft; a power transmission means (300) for transmitting rotational force of the cover shaft (200) to the mid-sheet shaft (100); and a body (400) accommodating the mid-sheet shaft (100) and the cover shaft (200) and rotatably supporting them in parallel with each other. The rolling type cover device of the present invention is used, which is easily transported and kept, winds a mid-sheet in a state where the mid-sheet is interposed between an inner surface and an outer surface of the cover, when the cover is wound, to prevent foreign substances stuck to the outer surface of the cover from being transferred to the inner surface of the cover, thereby durably preventing a two-wheeler or automobile from being contaminated, and can prevent the cover from being drawn out using a stopper to thereby maintain an appropriate tension of the cover and thus remarkably enhance the user's convenience.

### TECHNICAL FIELD

The present invention relates to a rolling type cover device, and more particularly, to a device, which draws out a cover and covers a two-wheeler or automobile with the cover to protect the vehicle and winds the cover to enable it to be kept conveniently when the cover is not utilized, wherein the rolling type cover device is used, whereby its transportation and safekeeping are easy, a mid-sheet is wound in a state where the mid-sheet is interposed between an inner surface and an outer surface of the cover, when the cover is wound, to prevent foreign substances stuck to the outer surface of the cover from being transferred to the inner surface of the cover, thereby durably preventing a two-wheeler or automobile from being contaminated, and the cover can be prevented from being drawn out using a stopper to thereby maintain an appropriate tension of the cover and thus remarkably enhance the user's convenience.

### BACKGROUND ART

In general, if a two-wheeler such as a bicycle or motorcycle is exposed to rain or snow when being parked, various parts such as a chain and the like is corroded. When an automobile is parked, there is a problem in that painting on a body of automobile is easily faded by foreign substances such as fallen leaves, sap or the like. Accordingly, when the two-wheeler and the automobile are parked, a vehicle body is covered with a separate cover to prevent the vehicle from being contaminated with various foreign substances such as rainwater, snow, dust, fallen leaves or sap.

However, since it is inconvenient to additionally load the aforementioned cover into the two-wheeler or automobile and to cover the vehicle with the cover, a rolling type cover device secured to a vehicle body has been devised.

The rolling type cover device secured to a vehicle body as described above has convenience in that a user draws out a cover wound on a roll and then cover a vehicle body with the cover in a state where the vehicle is parked, and the cover can be wound on the roll and kept when the device is not utilized, so that the rolling type cover device is employed in various types.

However, the conventional rolling type cover device secured to a vehicle body has a technical problem in that when the device is utilized, foreign substances stuck to an outer surface of the cover are transferred to an internal surface of the cover when the cover is wounded and kept, and the inner surface of the cover which is in contact with the vehicle body is easily contaminated according to repeat usage of the cover, whereby it is difficult to obtain sufficiently an advantage of the cover.

### DISCLOSURE OF INVENTION

### Technical Problem

The present invention is conceived to solve the aforementioned problems. An object of the present invention is to provide a rolling type cover device, wherein the rolling type cover device is used, whereby its transportation and safekeeping are easy, a mid-sheet is wound in a state where the mid-sheet is interposed between an inner surface and an outer surface of the cover, when the cover is wound, to prevent foreign substances stuck to the outer surface of the cover from being transferred to the inner surface of the cover, thereby durably preventing a two-wheeler or automobile from being contaminated, and the cover can be prevented from being drawn out using a stopper to thereby maintain an appropriate tension of the cover and thus remarkably enhance the user's convenience.

### Technical Solution

The present invention can be achieved by providing a rolling type cover device, which comprises a mid-sheet shaft having a mid-sheet wound thereon; a cover shaft rotating by a rotational force-inputting means to allow a cover and the mid-sheet to be stacked and wound on the cover shaft; a power transmission means for transmitting rotational force of the cover shaft to the mid-sheet shaft; and a body accommodating the mid-sheet shaft and the cover shaft and rotatably supporting them in parallel with each other.

### ADVANTAGEOUS EFFECTS

A rolling type cover device of the present invention as described above has advantages in that the rolling type cover device is used, whereby its transportation and safekeeping are easy, a mid-sheet is wound in a state where the mid-sheet is interposed between an inner surface and an outer surface of the cover, when the cover is wound, to prevent foreign substances stuck to the outer surface of the cover from being transferred to the inner surface of the cover, thereby durably preventing a two-wheeler or automobile from being contaminated, and the cover can be prevented from being drawn out using a stopper to thereby maintain an appropriate tension of the cover and thus remarkably enhance the user's convenience.

### BRIEF DESCRIPTION OF DRAWINGS

FIG. 1 is an exploded perspective view illustrating a rolling type cover device of the present invention;

FIG. 2 is a side view illustrating the rolling type cover device of the present invention;

FIG. 3 is an exploded perspective view of a major portion of the rolling type cover device of the present invention;

FIG. 4 is a view illustrating an example of the rolling type cover device of the present invention mounted to a two-wheeler; and

FIG. 5 is a view illustrating an example of the rolling type cover device of the present invention mounted to an automobile.

### EXPLANATION OF REFERENCE NUMERALS FOR MAJOR PORTIONS SHOWN IN DRAWINGS

100: Mid-sheet shaft 110: Mid-sheet
200: Cover shaft 210: Cover
220: Handle 230: Stop ring
240: Coil spring 250: Inclined ring
251: Inclined protrusion 300: Power transmission means
310: First gear 320: Second gear
330: Connecting gear 400: body
410: Upper casing 411: Discharging port
412: Stopper 413: Transporting knob
420: Lower casing 421: Foreign substance-removing blade
422: Foreign substance-discharging port
500: Support 510: Bracket
520: Leg

### BEST MODE FOR CARRYING OUT THE INVENTION

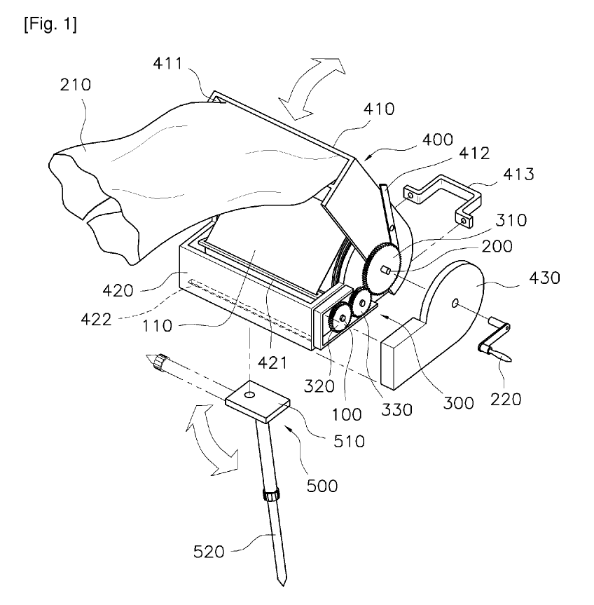

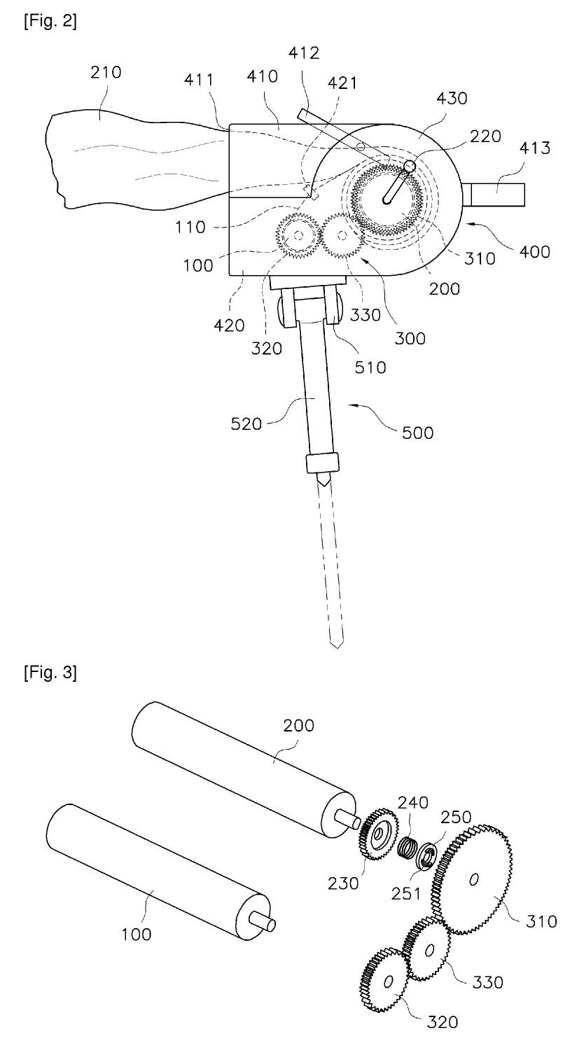

FIG. 1 is an exploded perspective view illustrating a rolling type cover device of the present invention, FIG. 2 is a side view illustrating the rolling type cover device of the present invention, and FIG. 3 is an exploded perspective view of a major portion of the rolling type cover device of the present invention.

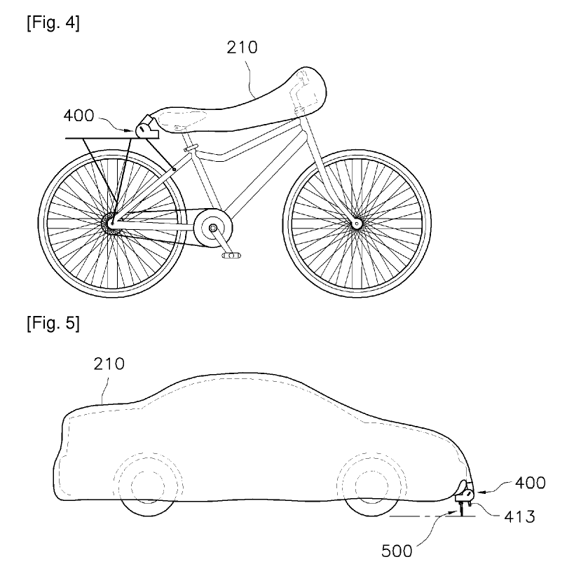

In addition, FIG. 4 is a view illustrating an example of the rolling type cover device of the present invention mounted to a two-wheeler, and FIG. 5 is a view illustrating an example of the rolling type cover device of the present invention mounted to an automobile.

An embodiment of the present invention will be described in detail with reference to the accompanying drawings.

As shown in FIGS. 1 and 2, a rolling type cover device of the present invention is basically characterized in that the cover device includes a cover shaft 200 provided in a body 400 to wind a cover 210 according to rotation and a mid-sheet shaft 100, which is provided at one side of the cover shaft 200, and on which a mid-sheet 110 is, and the cover shaft 200 and the mid-sheet shaft 100 cooperate and rotate by a power transmission means 300 so that the cover 210 and the mid-sheet 110 are wound on the cover shaft 200 while being stacked, thereby causing the mid-sheet 110 to prevent foreign substances stuck to an outer surface of the cover 210 from being transferred to an inner surface of the cover 210.

Hereinafter, each of the components of the rolling type cover device according to the preferred embodiment of the present invention will be described as follows with reference to the drawings.

Here, a rotation direction of the mid-sheet shaft 100 or the cover shaft 200 will be described bellow as a clockwise or counterclockwise direction with respect to FIGS. 1 and 2.

First, the mid-sheet shaft 100 is a roller-shaped shaft and the mid-sheet 110 is wound on the mid-sheet shaft 100, so that the mid-sheet 110 is wound by the counter-clockwise rotation and unwound by the clockwise rotation. Preferably, the mid-sheet 110 is in the form of a film, which can be durably used in the hottest season and the coldest season without damage, and which foreign substances such as rainwater, snow, dust, sap and the like do not penetrate.

In addition, the cover shaft 200 is also a roller-shaped shaft and rotates through rotational force inputted by a rotational force-inputting means which will be described later. The mid-sheet 110 and the cover 210 are wound while being stacked according to the clockwise rotation of the cover shaft 200 and unwound according to the counter-clockwise rotation thereof.

At this time, an automobile or a two-wheeler such as a bicycle or motorcycle is partially or entirely covered with the cover 210, so that in order to prevent the automobile or two-wheeler from being contaminated by foreign substances such as snows, dusts, fallen leaves or sap, it is preferable that the cover 210 is formed of a fabric material that is completely waterproof and fireproof.

Here, as the cover 210 is pulled to utilize the cover 210, the cover shaft 200 rotates counterclockwise and unwinds the cover 210. However, the rotational force-inputting means is provided for rotating the cover shaft 200 clockwise to wind the cover 210 which was drawn out.

Fundamentally, a manual type device through which a user directly exerts rotational force can be used as the rotational force-inputting means, and the rotational force-inputting means preferably includes a handle 220 connected to one of both ends of the cover shaft 200.

That is, the handle 220, as an additional member, is selectively connected to any one of both the ends of the cover shaft 200 to enable the cover shaft 200 to be rotated by rotating the handle 220, so that the cover 210 and the mid-sheet 110 are wound on the cover shaft 200 while being stacked.

Similarly, although not shown, an electric-powered type in which an electric-powered motor generates rotational force through switch control may be used as the rotational force-inputting means. Preferably, a driving motor operating by supplying electric power thereto is used as the rotational force-inputting means.

In addition, a power transmission means 300 for transmitting rotational force of the cover shaft 200 to the mid-sheet shaft 100 is provided for enabling the cover shaft 200 and the mid-sheet shaft 100 to cooperate with each other and rotate in the same direction.

Here, a rotational speed of the cover shaft 200 and a rotational speed of the mid-sheet shaft 100 will be compared. When a plenty of the cover 210 and the mid-sheet 110 are wound on the cover shaft 200, the diameter of the cover shaft 200 is increased, while when a plenty of the cover 210 and the mid-sheet 110 are unwound from the cover shaft 200, the diameter of the cover shaft 200 is decreased. Accordingly, a change ratio of the diameter of the cover shaft 200 is large.

However, since only the thin film type mid-sheet 110 is wound on or unwound from the mid-sheet shaft 100, a change of the diameter of the mid-sheet shaft 100 is somewhat small.

That is, since a difference in the rotational speed between the cover shaft 200 and the mid-sheet shaft 100 is always generated according to the thickness of the cover 210 and the mid-sheet 110 wound on the cover shaft 200, one embodiment in which a rotation ratio is constantly maintained and another embodiment in which a rotation ratio is variable will be separately described below.

First, in the embodiment in which the rotation ratio is constantly maintained, although a belt or chain may be employed as the power transmission means 300, the power transmission means 300 of the present invention preferably comprises a first gear 310 provided on the cover shaft 200, a second gear 320 provided on the mid-sheet shaft 100 and a connecting gear 330 meshed with the first gear 310 and the second gear 320.

At this time, the first gear 310 is secured to and rotates together with the cover shaft 200, and the second gear 320 is secured to and rotates together with the mid-sheet shaft 100.

Accordingly, a rotation ratio between the cover shaft 200 and the mid-sheet shaft 100 is always constant, and the two shafts can cooperate with each other and rotate in the same direction. At this time, it is preferable to set up a rotation ratio between the cover shaft 200 and the mid-sheet shaft 100 appropriately according to the diameters of the two shafts and thicknesses of the cover 210 and the mid-sheet 110 wound on the shafts. In the present invention, the mid-sheet shaft 100 preferably rotates one or more revolutions when the cover shaft 200 rotates one revolution.

Second, in the embodiment in which the rotation ratio is variable, as shown in FIG. 3, a stop ring 230, a coil spring 240 and an inclined ring 250 having inclined protrusions 251 formed thereon are added between the cover shaft 200 and the first gear 310. The mid-sheet shaft 100 rotates together with the second gear 320 by friction force therebetween when torque below a certain value is exerted, while the mid-sheet shaft 100 idles by slip therebetween when torque exceeds a certain value.

At this time, the cover shaft 200 rotates together with the disc-shaped stop ring 230, and the inclined ring 250 elastically supported in the stop ring 230 by the coil spring 240 rotates together therewith.

In particular, the two or more inclined protrusions 251 which protrude in a spiral shape are formed on an outer surface of the inclined ring 250, and inclined protrusions, which are not shown, corresponding to the inclined protrusions 251 are formed in an opposite direction on an inner surface of the first gear 310.

In addition, the first gear 310 is rotatably supported to the cover shaft 200 in an idle state.

Accordingly, when the cover 210 and the mid-sheet 110 are unwound from the cover shaft 200, all the cover shaft 200, the stop ring 230 and the inclined ring 250 rotate counterclockwise, and the inclined protrusions formed on the inner surface of the first gear 310 supported to the cover shaft 210 in an idle state is engaged with the protrusions 251 formed on the inclined ring 250 and thus rotates counterclockwise.

Then, the rotational force of the first gear 310 is transmitted to the second gear 320 through the connecting gear 330 to cause the mid-sheet shaft 100 to rotate, whereby the mid-sheet shaft 100 rotates counterclockwise at a rotational speed larger than that of the cover shaft 200 to wind the mid-sheet 110 unwound from the cover shaft 200. If the rotational speed of the mid-sheet shaft 100 on which the mid-sheet 110 is wound is larger than that of the cover shaft 200 from which the mid-sheet 110 is unwound, the mid-sheet shaft 100 slides from and slips on the second gear 320 by tension exerted to the mid-sheet 110.

On the contrary, when a user rotates the cover shaft 200 clockwise using the handle 220 to wind the cover 210 and the mid-sheet 110 on the cover shaft 200, the stop ring 230 and the inclined ring 250 rotate together with the cover shaft 200. However, the coil spring 240 supporting the inclined ring 250 is contracted, so that the inclined protrusions 251 formed on the inclined ring 250 go over the inclined protrusions (not shown) formed on an inner surface of the first gear 310.

Accordingly, even though the cover shaft 200 rotates clockwise, the first gear 310 is maintained in an idle state, and as the mid-sheet 110 is wound on the cover shaft 200, the mid-sheet 110 wound on the mid-sheet shaft 100 is unwound so that the mid-sheet shaft 100 rotates clockwise.

Then, although the second gear 320, the connecting gear 330 and the first gear 310 rotate together according to the rotation of the mid-sheet shaft 100, the mid-sheet shaft 100 rotates only by the rotational force generated when the mid-sheet 110 is unwound from the mid-sheet shaft 100, and the first gear 310, the second gear 320 and the connecting gear 330 do not apply the rotational force to the cover shaft 200.

Even though a difference in the rotational speed between the cover shaft 200 and the mid-sheet shaft 100 is generated according to a change of the thickness of the cover 210 and the mid-sheet 110 wound on the cover shaft 200, the smooth operation can be performed by the aforementioned configuration.

Finally, the body 400 is a component, in which the mid-sheet shaft 100 and the cover shaft 200 are accommodated to be rotatably supported in parallel, and is preferably made of a synthetic resin injection mold which is lightweight and has a high strength.

Here, since the power transmission means 300 is provided at a side surface of the body 400, it is preferable to provide an additional cover 430 for preventing the power transmission means 300 from being exposed to the outside.

At this time, the body 400 may be formed as a single body. In the present invention, however, the body 400 is divided into an upper casing 410 and a lower casing 420, wherein the upper casing 410 is connected to the lower casing 420 rotatably about the cover shaft 200, the mid-sheet shaft 100 is provided in the lower casing 420, and most preferably, a discharging port 411 of the cover 210 is formed on the upper casing 410.

That is, in a state where the upper casing 420 is horizontally secured to a vehicle body, the upper casing 410 rotates about the cover shaft 200 at a certain angle, which makes it possible to discharge the cover 210 through the discharging port 411.

In addition, a foreign substance-removing blade 421 which is in contact with both the surfaces of the mid-sheet 110 is preferably provided in the lower casing 420.

At this time, the foreign substance-removing blade 421 is a plate member made of rubber and the like with a slot formed in a center thereof, and removes foreign substances stuck to both the surfaces of the mid-sheet 110 when the mid-sheet 110 passes through the slot.

In the present invention, in particular, the foreign substance-removing blade 421 is preferably inclined fixed at a certain angles, and a foreign substance-discharging port 422 is formed at a lower portion of the lower casing 420.

That is, the foreign substance-removing blade 421 is slantingly fixed in the lower casing 420, the foreign substances removed from the mid-sheet 110 by the foreign substance-removing blade 421 can be collected on one side in the lower casing 420. In addition, the foreign substances collected on one side in the lower casing 420 may be discharged to the outside through the foreign substance-discharging port 422 shown in FIG. 1.

In the present invention, in addition, it is preferable to provide a stopper 412 on the upper casing 410 to selectively restrict the rotation of the cover shaft 200.

That is, the stopper 412 is a rod-shaped component capable of adjusting the rotation of the upper casing 410 from the outside of the upper casing 410, and has a wedge formed on an end thereof so that the cover shaft 200 is caught to the wedge to prevent the cover shaft 200 from rotating.

At this time, teeth are additionally formed on an outer circumference of the stop ring 230 that rotates together with the cover shaft 200, thereby allowing the wedge of the stopper 412 to be meshed selectively with the teeth of the stop ring 230.

Accordingly, if the stopper 412 is meshed with the stop ring 230, the rotation of the cover shaft 200 is restricted, so that the cover 210 wound on the cover shaft 200 is not unwound any more. Simultaneously, in this state, if the upper casing 410 which is positioned slantingly at a certain angle with respect to the lower casing 420 is rotated about the cover shaft 200, an appropriate tension is applied to the cover 210 with which a vehicle body is covered, so that the cover 210 is not taken off from the vehicle body.

In particular, the rolling type cover device including the aforementioned components may be used in a state of being secured to a bicycle or motorcycle. The rolling type cover device may be used while being temporarily mounted to a bumper of a vehicle using a support 500, which will be described later.

That is, the support 500 is additionally provided at a bottom of the lower casing 420. Preferably, the support 500 includes a bracket 510 which is fixedly coupled to the bottom of the lower casing 420 and a leg 520 which is foldable with respect to the bracket 510 and is selectively extended and retracted.

Here, the bracket 510 is secured to the bottom of the lower casing 420. The leg 520 is has a coil spring provided therein or working fluid hermetically received therein, and a length of the leg is elastically extended by operation of a user. In a state where the lower casing 420 is mounted to a bumper of a vehicle, if the leg 520 is extended, the leg is elastically supports the bracket 510 on the ground and thus serves to brought into contact with a lower portion of the bumper.

At this time, it is preferable that the bracket 510 and the leg 520 are supported not to be perpendicular to the ground but to be inclined at a certain angle with respect thereto.

It will be apparent that if the leg 520 is not utilized, it is possible to shorten the length of the leg and then keep the leg.

In addition, a transporting knob 413 is additionally provided on the upper casing 410 to enable a user to transport the rolling type cover device of the present invention or to load the device into the vehicle using the transporting knob 413 when the cover 210 is not utilized.

Hereinafter, referring to FIGS. 4 and 5, the rolling type cover device of the present invention is divided into the fixed type device applied to a bicycle or motorcycle and the detachable type device applied to the vehicle, each operation of which will be described as follows.

First, the fixed type cover device applied to a two-wheeler has the lower casing 420 of the body 400 fixedly installed on a carrier provided behind a saddle as shown in FIG. 4 or fixedly installed at a front of a handle, wherein the aforementioned transporting knob 413 and the support 500 are excluded.

At this time, the cover 210 and the mid-sheet 110 are stacked and wound on the cover shaft 200.

In this state, in order to draw out the cover 210 and cover a body of a two-wheeler, a user pulls and draws out the cover 210.

Accordingly, the cover shaft 200 rotates counterclockwise and the cover 210 is unwound therefrom. Simultaneously, the first gear 310 provided on the cover shaft 200 rotates and thus the connecting gear 330 rotates in an opposite direction thereof, i.e., clockwise. Since the second gear 320 rotates counterclockwise together with the first gear 310 and makes the mid-sheet shaft 100 rotate, the mid-sheet 110 wound on the cover shaft 200 is wound on the mid-sheet shaft 100.

In particular, when the mid-sheet 110 is wound on the mid-sheet shaft 100, while the mid-sheet 110 passes through the slot of the foreign substance-removing blade 421, the foreign substances stuck on both the surfaces of the mid-sheet 110 are removed and then collected on one side in the lower casing 420. Then, the collected foreign substances are discharged to the outside through the foreign substance-discharging port 422.

At this time, although the lower casing 420 of the body 400 is secured to a vehicle body, since the upper casing 410 can rotate about the lower casing 420, it is possible to properly adjust the direction of the discharging port 411 to discharge the cover 210.

After a user pulls the cover 210 and covers the vehicle body therewith, the user handles the stopper 412 provided on the upper casing 410 to restrict the cover shaft 200 from further rotating. Simultaneously, if the user pushes the upper casing 410 to locate the upper casing 410 horizontally so as to bring the upper casing 410 into contact with the lower casing 420, the appropriate tension is exerted on the discharged cover 210, so that the cover 210 with which a vehicle body is covered is not taken off.

Then, in order to remove the cover 210 from the vehicle body, the user connects the handle 220 to any one of both the ends of the cover shaft 200 and then rotates the handle 220. If a driving motor is employed in the present invention, the cover shaft 200 rotates clockwise by supplying electric power to the driving motor, thereby winding the cover 210 on the cover shaft 200.

At this time, in the embodiment in which a rotation ratio between the cover shaft 200 and the mid-sheet shaft 100 is constant, the mid-sheet shaft 100 always rotates at a constant rotation ratio by the rotation of the cover shaft 200, so that the mid-sheet 110 wound on the mid-sheet shaft 100 is unwound and stacked together with the cover 210, whereby the mid-sheet 110 and the cover 210 are kept in a state of being wound on the cover shaft 200.

However, in the embodiment in which a rotation ratio between the cover shaft 200 and the mid-sheet shaft 100 is variable, as the mid-sheet 110 is wound on the cover shaft 200, the mid-sheet shaft 100 rotates clockwise by the tension exerted on the mid-sheet 110 to unwind the mid-sheet 110.

Next, in the detachable type cover device applied to a vehicle, the lower casing 420 of the body 400 is selectively mounted to a front or rear bumper as shown in FIG. 5.

The basic operation of the detachable type cover device, which is the same as that of the fixed type cover device, will be omitted, and only differences therebetween will be described as follows.

First of all, in order to easily transport the rolling type cover device according to the present invention when the cover 210 is not utilized, the transporting knob 413 is provided on the upper casing 410 of the body 400. Further, in order to mount the rolling type cover device according to the present invention to a front or rear bumper of a vehicle, the support 500 is provided on the lower casing 420 of the body 400.

For example, in a case where the rolling type cover device is mounted to the front bumper of the vehicle, the upper casing 410 is rotated about the cover shaft 200 with respect to the lower casing 420 of the body 400 to make lower and front portions of the bumper be surrounded with the upper casing 410.

At this time, since the bracket 510 and the leg 520 of the support 500 are inclined at a certain angle, the body 400 is more securely and closely contacted with the bumper.

Then, the leg 520 is unfolded with respect to the bracket 510 of the support 500 and the length of the leg 520 is elastically extended, so that a lower end of the leg 520 is supported on the ground and the body 400 comes into close contact with and is secured to the bumper.

In such a state, the cover 210 can be drawn out to cover the vehicle body. In a state where the cover 210 is wound again, the leg 520 is shortened and then folded in reverse order. Then, it is possible to easily take on the cover device into a trunk of the vehicle using the transporting knob 413.

Accordingly, as shown in FIGS. 1 to 5, the rolling type cover device of the present invention so configured may be utilized as the fixed type cover device for a two-wheeler such as a bicycle or motorcycle and may be utilized as the detachable type cover device for a vehicle. In particular, the present invention has an excellent advantage in that when the cover 210 is wound on the cover shaft 200, the mid-sheet 110 is wound in a state of being stacked therebetween, so that it is possible to prevent foreign substances stuck to an outer surface of the cover 210 from being transferred to an inner surface of the cover 210 to thereby preventing the inner surface of the cover 210 from being contaminated.

In addition, there are advantages in that the foreign substance-removing blade 421 may be provided to discharge foreign substances stuck to the mid-sheet 110 through the foreign substance-discharging port 422 without additional operation, the tension of the cover 210 covering a vehicle body can be maintained properly using the stopper 412 provided on the upper casing 410, and the transporting know 413 or the support 500 is provided, so that the cover device can be selectively mounted to and detached from the vehicle body and easily transported.

In particular, the coil spring 240 and the inclined spring 250 having the inclined protrusions 251 formed are employed, so that when the cover 210 is unwound, rotational force is exerted on the mid-sheet shaft 100 to wind the mid-sheet 110. However, when the cover 210 is wound, the tension exerted on the mid-sheet 110 causes the mid-sheet shaft 100 to rotate, so that although there is a difference in a rotational speed between the cover shaft 200 and the mid-sheet shaft 100, the mid-sheet 110 is wound on or unwound from the mid-sheet shaft 100 in a state where the proper tension on the mid-sheet 110 is always maintained, thereby preventing the mid-sheet 110 from being tangled or twisted in the body 440.

The aforementioned embodiments are only an example for specifically illustrating the technical sprit of the present invention, and the scope of the present invention is not limited to the drawings or the embodiment.

1. A rolling type cover device, comprising:
a mid-sheet shaft having a mid-sheet wound thereon;
a cover shaft rotating by a rotational force-inputting means to allow a cover and the mid-sheet to be stacked and wound on the cover shaft;
a power transmission means for transmitting rotational force of the cover shaft to the mid-sheet shaft; and
a body accommodating the mid-sheet shaft and the cover shaft and rotatably supporting them in parallel with each other.

2. The rolling type cover device as claimed in claim 1, wherein the rotational force-inputting means is a handle connected to any one of both ends of the cover shaft.

3. The rolling type cover device as claimed in claim 1, wherein the body is divided into an upper casing and a lower casing, the upper casing is connected to the lower casing rotatably about the cover shaft, the mid-sheet shaft is provided in the lower casing, and a discharging port of the cover is formed on the upper casing.

4. The rolling type cover device as claimed in claim 3, wherein the lower casing has a foreign substance-removing blade provided therein, the foreign substance-removing blade being in contact with both surfaces of the mid-sheet.

5. The rolling type cover device as claimed in claim 4, wherein the foreign substance-removing blade is slantingly fixed, and the lower casing has a foreign substance-discharging port formed at a lower portion thereof.

6. The rolling type cover device as claimed in claim 3, wherein the power transmission means comprises a first gear provided in the cover shaft, a second gear provided in the mid-sheet shaft, and a connecting gear provided between and meshed with the first gear and the second gear.

7. The rolling type cover device as claimed in claim 6, wherein the upper casing has a stopper provided thereon, the stopper selectively restricting the cover shaft from rotating.

8. The rolling type cover device as claimed in claim 3, wherein a support is further provided on a bottom of the lower casing, the support comprises a bracket fixedly coupled to the bottom of the lower casing and a leg being foldable with respect to the bracket and selectively extended and retracted.
